(19) United States
(12) Patent Application Publication
(10) Pub. No.: US 2025/0360735 A1
(43) Pub. Date: Nov. 27, 2025

(54) WINDING DEVICE AND PRINTING AND WINDING SYSTEM

(71) Applicant: SEIKO EPSON CORPORATION, Tokyo (JP)

(72) Inventor: Daichisehan IWAMA, MATSUMOTO-SHI (JP)

(21) Appl. No.: 19/213,564

(22) Filed: May 20, 2025

(30) Foreign Application Priority Data
May 21, 2024 (JP) 2024-082702

(51) Int. Cl. B41J 15/16

(52) U.S. Cl. CPC B41J 15/16

(57) ABSTRACT

A winding device includes a winding section that winds up a print medium discharged from a printing device, a support shaft that rotatably supports the winding section, and a drive force transmission member that transmits drive force for rotating the winding section from the printing device to the winding section, wherein the winding section has a winding core configured to wind up the print medium around a peripheral surface thereof and a flange configured to guide a winding position of the print medium when winding up the print medium around the winding core, the winding device is configured to rotate the winding core by engaging a first engagement section provided on the drive force transmission member with a second engagement section of the flange, and the winding core is configured to be movable in an shaft direction along the support shaft.

The present application is based on, and claims priority from JP Application Serial Number 2024-082702, filed May 21, 2024, the disclosure of which is hereby incorporated by reference herein in its entirety.

### BACKGROUND

### 1. Technical Field

The present disclosure relates to a winding device and a printing and winding system.

### 2. Related Art

JP-A-2015-134686 discloses a winding device equipped with a winding section that winds print paper that is a print medium discharged from a printing device, a support shaft that rotatably supports the winding section, and a drive force transmission member that transmits drive force for rotating the winding section from the printing device to the winding section.

However, in JP-A-2015-134686, the winding section does not move in a shaft direction of the support shaft. Therefore, if the end of the print paper in the printing device varies, the winding operation may be performed while the print medium is strongly in contact with a side surface of a flange provided in the winding section, resulting in a winding failure.

### SUMMARY

In order to overcome the above problem, one aspect of a winding device includes a winding section that winds up a print medium discharged from a printing device; a support shaft that rotatably supports the winding section; and a drive force transmission member that transmits, from the printing device to the winding section, a drive force for rotating the winding section, wherein the winding section has a winding core configured to wind up the print medium around a peripheral surface of the winding core and a flange configured to guide a winding position of the print medium when winding up the print medium around the winding core, the drive force transmission member is configured to rotate the winding core by engaging a first engagement section provided on the drive force transmission member with a second engagement section provided on the flange, and the winding core is configured to be movable in a shaft direction along the support shaft.

In order to overcome the above problem, another aspect is a printing and winding system that includes the winding device and the printing device.

### BRIEF DESCRIPTION OF THE DRAWINGS

FIG. 1 is a perspective view of a printing and winding system as viewed from a front side.

FIG. 2 is a side view of a main components of the printing and winding system, showing various parts related to a transport path.

FIG. 3 is another side view of the main components of the printing and winding system, showing various parts related to the transport path.

FIG. 4 is still another side view of the main components of the printing and winding system, showing various parts related to the transport path.

FIG. 5 is a V-V cross-sectional view of FIG. 4.

FIG. 6 is an enlarged view showing a range of VI in FIG. 5.

FIG. 7 is an enlarged view showing a range of VII in FIG. 5.

FIG. 8 is a plan view showing an outline of a printing and winding system 1.

FIG. 9 is a plan view showing another outline of the printing and winding system 1.

FIG. 10 is a plan view showing still another outline of the printing and winding system 1.

FIG. 11 Is a plan view showing further another outline of the printing and winding system 1.

FIG. 12 Is a plan view showing further another outline of the printing and winding system 1.

FIG. 13 is an enlarged view of a range VI in FIG. 5 according to the modification.

### DESCRIPTION OF EMBODIMENTS

Hereinafter, embodiments of the present disclosure will be described with reference to the drawings. Note that in the description, directions such as front, rear, left, right, up, and down are the same as the directions with respect to a printing device 2 illustrated in the drawings unless otherwise specified. Note that a reference symbol FR shown in each drawing indicates a front side of the printing device 2, a reference symbol UP indicates an upper side of the printing device 2, and a reference symbol LH indicates a left side of the printing device 2.

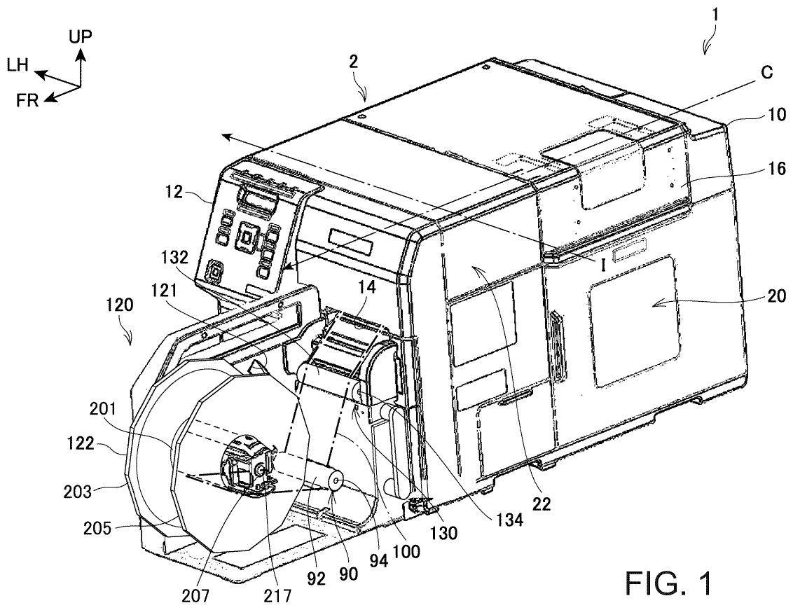

FIG. 1 is a perspective view of a printing and winding system 1 as viewed from the front side. In FIG. 1, for convenience of description, a transport direction C, an intersecting direction I, and a print medium 100 are indicated by dashed-dotted line. As shown in FIG. 1, a printing and winding system 1 is equipped with a printing device 2 and a winding device 120 that is attached to the printing device 2. The printing device 2 is a so-called line-type inkjet printer that includes a line inkjet head, and that ejects ink from the inkjet head to print characters and images on a print medium.

The print medium used for printing in the printing device 2 is a continuous sheet, and is formed of paper, synthetic resin, or the like. For example, it may be a fine paper suitable for ink jet printing, which has been subjected to a surface treatment that enhances ink absorption and fixability.

The continuous sheet includes roll paper, which is accommodated in the printing device 2 in a state of being wound in a roll shape, and fanfold paper in a folded state that is supplied to the printing device 2 from outside the printing device 2. In addition to plain paper or fine paper rolled into a roll shape, label paper may be used as roll paper, in which standard size labels with adhesive on the reverse side are arranged on peel-away paper, which is the base paper, and rolled into a roll shape.

The printing device 2 is equipped with a device case 10. The device case 10 forms an outer shell of the printing device 2 by combining a side panel, a front panel, and the like. On the front surface of the device case 10, a display and operation panel 12 on which a display, operation buttons, and the like are arranged is provided on the upper half on the left side of the front surface. On the front surface of the device case 10, a slit-shaped sheet discharge port 14 extending in a left-right direction is formed at substantially the center on the right side. The printing device 2 discharges a print medium 100 from the sheet discharge port 14.

A sheet cover 16 is provided in an openable and closable manner from the right side surface to the upper surface in the rear portion of the device case 10. Inside the sheet cover 16, an accommodation section 20 is provided. In the printing device 2, by opening the sheet cover 16, the print medium 100 wound in a roll shape can be loaded into the accommodation section 20.

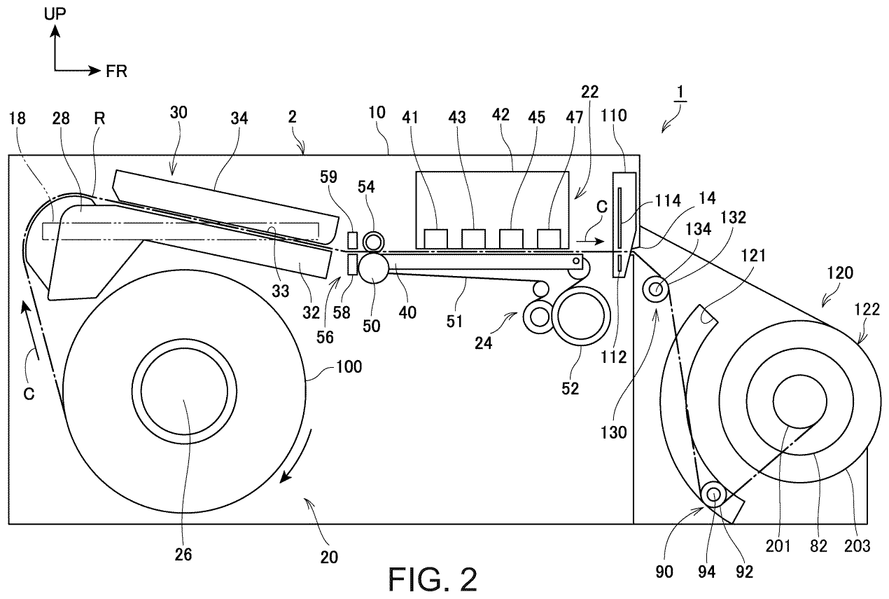

FIG. 2 is a side view of main components of the printing and winding system 1, showing each part related to a transport path R of the printing and winding system 1. In FIG. 2, for convenience of description, the print medium 100 in the transport path R is indicated by dashed-dotted line. In the subsequent drawings, similar to FIG. 2, for convenience of description, the print medium 100 in the transport path R is indicated by dashed-dotted printing device 2 is equipped with the accommodation section 20 that accommodates the print medium 100, a printing section 22 that performs printing on the print medium 100, and a transport section 24 that transports the print medium 100 from the accommodation section 20 to the printing section 22. The accommodation section 20 is provided on the rear side, and the printing section 22 is provided on the front side from the accommodation section 20. The transport section 24 is provided below the printing section 22.

The accommodation section 20 has a roll shaft 26 to which the print medium 100 is attached. The roll shaft 26 is a rod-shaped member that is rotatable in a circumferential direction. The print medium 100 is accommodated in the accommodation section 20 by inserting the roll shaft 26 into the center of the roll of the print medium 100. The roll shaft 26 may be connected to a drive device, for example, a motor, and may rotate with a drive of the drive device. In the printing device 2, the print medium 100 rotates as the roll shaft 26 rotates.

The transport path R is formed in the printing device 2, along which one end of the print medium 100 attached to the roll shaft 26 is pulled out and transported to the sheet discharge port 14. In the transport path R, a tension lever 28 is attached above the print medium 100 accommodated in the accommodation section 20. The tension lever 28 has a curved surface in the circumferential direction, and is formed in a cylindrical shape extending in the left-right direction. The tension lever 28 applies tension to the print medium 100 to prevent slacking. The print medium 100 is pulled upward at one end, contacts the tension lever 28, is bent, and then extends forward.

A paper guide unit 30 is provided in the front side of the tension lever 28. The paper guide unit 30 guides the print medium 100 forward, and suppresses skew of the print medium 100 and deviation of transport of the print medium 100.

The paper guide unit 30 has a lower guide member 32 for supporting the print medium 100 from below, and a paper pressing member 34 located on the upper surface side of the print medium 100. The print medium 100 is transported in a state of being sandwiched between the lower guide member 32 and the paper pressing member 34 in the paper guide unit 30.

The printing section 22 for printing on the print medium 100 is provided in the front side of the paper guide unit 30. The printing section 22 has a platen 40 and a print head 42. The print head 42 in this embodiment ejects inks of four colors of cyan (C), magenta (M), yellow (Y), and black (K) to form dots on a print surface of a label. The print head 42 has a nozzle section 41 that ejects K (black) ink, a nozzle section 43 that ejects C (cyan) ink, a nozzle section 45 that ejects M (magenta) ink, and a nozzle section 47 that ejects Y (yellow) ink.

In the nozzle sections 41 to 47, a plurality of nozzles for ejecting ink are arranged in a row in a width direction of the print medium 100. The nozzles of the nozzle sections 41 to 47 are arranged along the intersecting direction I, which intersects the transport direction C. As shown in FIG. 1, in the present embodiment, the intersecting direction I is a direction orthogonal to the transport direction C. The intersecting direction I corresponds to the width direction of the print medium 100.

The print head 42 is a line inkjet head capable of ejecting ink without scanning in the width direction of the print medium 100. Therefore, the nozzle rows of the nozzle sections 41 to 47 are formed to have at least the same width as or wider than a printable range of the print medium 100. In the present embodiment, the printable range corresponds to a print surface of the label. In the present embodiment, a configuration example in which the nozzle sections 41, 43, 45, and 47 are arranged in this order along the transport direction C of the print medium 100 is described, but the arrangement order of the nozzles of each color in the transport direction C is arbitrary.

The platen 40 has a flat surface arranged along the transport direction C. This flat surface is located below the transport path R and faces the print head 42. The nozzle sections 41 to 47 and the platen 40 are arranged with a gap between them, which is a so-called platen gap. The platen 40 supports the print medium 100 from below. The platen 40 is provided over at least the entire print range in the printing section 22. The flat surface of the platen 40 is arranged substantially horizontally in the installation state and in the state of use of the printing device 2.

The transport section 24 is equipped with a cylindrical shape transport roller 50. The transport roller 50 is provided with its longitudinal direction extending along the intersecting direction I, and is provided rotatably in the circumferential direction. The transport roller 50 is arranged in the front side of the paper guide unit 30 and at the rear end of the platen 40.

A driven wheel is provided at one end section of the transport roller 50, for example. A movement transmission belt 51 winds around the driven wheel. The movement transmission belt 51 winds around a drive shaft of a transport motor 52. By this, the transport roller 50 and the transport motor 52 are connected to each other via the movement transmission belt 51. The transport motor 52 is a drive device that rotates and drives the transport roller 50. The transport motor 52 is rotatable in two directions, that is, a direction to feed the print medium 100 from the accommodation section 20 toward the sheet discharge port 14 and a direction to feed the medium 100 from the sheet discharge port 14 toward the printing section 22. The transport motor 52 and the movement transmission belt 51 are located below the platen 40.

The transport section 24 has a plurality of paper feed driven rollers 54. The plurality of paper feed driven rollers 54 are rotatably arranged along the longitudinal direction of the transport roller 50. Each of the paper feed driven rollers 54 is biased so that its peripheral surface is in contact with the peripheral surface of the transport roller 50. By this, the transport roller 50 and the paper feed driven rollers 54 are arranged to face each other. Therefore, the transport roller 50 is arranged on the lower guide member 32 side, and the paper feed driven roller 54 is arranged on the paper pressing member 34 side.

In the transport section 24, the transport motor 52 is driven to rotate and drive the transport roller 50 via the movement transmission belt 51, and the paper feed driven roller 54 is driven to rotate following the transport roller 50. By this, the print medium 100 loaded between the lower guide member 32 and the paper pressing member 34 is sandwiched between the transport roller 50 and the paper feed driven roller 54, and is transported to the printing section 22 as the transport roller 50 is driven to rotate. When the print medium 100 is transported to the printing section 22, the print medium 100 is printed by the printing section 22. Thereafter, the print medium 100 is discharged from the sheet discharge port 14 by the drive of the transport section 24.

The printing device 2 can pull back the print medium 100 discharged from the sheet discharge port 14 to the printing section 22 by driving the transport motor 52 in the reverse direction of the rotation direction that feeds the print medium 100 from the accommodation section 20 toward the sheet discharge port 14. Then, the printing device 2 can print on the print medium by the printing section 22 again. In the following description, a direction in which the print medium 100 is fed from the accommodation section 20 toward the sheet discharge port 14 is referred to as a forward feed direction, and a direction in which the print medium 100 is pulled back from the sheet discharge port 14 toward the printing section 22 is referred to as a reverse feed direction.

Note that the transport roller 50 may be arranged on the lower guide member 32 side, in other words, on the paper guide unit 30 side. The transport section 24 may be equipped with, instead of the transport roller 50, a transport belt that can move over the upper surface of the platen 40, for example.

The printing device 2 is provided with a label detecting device 56 downstream from the paper guide unit 30 and upstream from the transport roller 50 in the transport path R. The label detecting device 56 detects a leading end and a trailing end of the print medium 100 and a leading end and a trailing end of the label. The label detecting device 56 is, for example, an optical transmissive sensor that has a light emitting section 58 on the lower surface side of the print medium 100 and a light receiving section 59 on the upper surface side of the print medium 100 in the transport path R. The light emitting section 58 and the light receiving section 59 are arranged to face each other along the vertical direction with a gap through which the print medium 100 can pass. In other words, the light emitting section 58 and the light receiving section 59 are arranged at substantially the same position in the front-rear direction.

Note that the label detecting device 56 may be arranged on the downstream side of the transport roller 50 and on the upstream side of the print head 42. The light emitting section 58 may be arranged on the paper pressing member 34 side, and the light receiving section 59 may be arranged on the lower guide member 32 side, for example. Similarly, the light emitting section 58 may be arranged on the platen 40 side, and the light receiving section 59 may be arranged on the print head 42 side.

A light emitting element such as a light emitting diode (LED) is used for the light emitting section 58. A light receiving element such as a phototransistor, a photo IC, a photodiode is used for the light receiving section 59. When the light receiving element receives light with a signal strength equal to or greater than a predetermined value, the light receiving element outputs a detection voltage as an output value indicating the amount of received light, depending on the amount of received light.

In the label detecting device 56, the light emitting section 58 and the light receiving section 59 are arranged in a position where the light receiving section 59 can receive light emitted from the light emitting section 58 with a predetermined signal strength. In this case, the output value of the light receiving section 59, which indicates the amount of received light, is different for each of the cases where there is no print medium 100 directly below the light receiving section 59, where there is a base paper, and where there is a label. Therefore, the label detecting device 56 can detect the leading end and the trailing end of the print medium 100 and the leading end and the trailing end of the label based on the output value of the light receiving section 59 indicating the amount of received light.

A cutter unit 110 is arranged on the downstream side of the print head 42, that is, on the front side. The cutter unit 110 has a fixed blade 112 and a movable blade 114 that are arranged with the transport path R interposed therebetween, and the movable blade 114 is connected to a drive device such as a motor that drives the cutter via a gear or the like. In the cutter unit 110, when the motor is driven, the movable blade 114 moves toward the fixed blade 112 and cuts the print medium 100. The cutter unit 110 may cut the print medium 100 so as to leave a part of the medium 100 uncut in the width direction, or may completely cut the print medium 100. The printing device 2 cuts the print medium 100 printed by the print head 42 into a predetermined length by the cutter unit 110, and discharges the cut print medium 100 from the sheet discharge port 14. Note that the cutter unit 110 is formed separately from the printing device 2, and may be detachably provided on the front surface of the printing device 2, for example.

The printing device 2 is equipped with a control substrate 18 that controls each section of the printing device 2. The control substrate 18 has a CPU, ROM, RAM, and the like, as the calculation execution section. In the ROM of the control substrate 18, firmware executable by the CPU, data related to the firmware, and the like are stored in a nonvolatile manner. The RAM temporarily stores data and the like related to the firmware executed by the CPU. The control substrate 18 may have other peripheral circuits and the like. The control substrate 18 may have a storage section capable of storing various programs and data, such as control programs and data related to the control programs, in a nonvolatile manner.

The control substrate 18 is formed to be able to detect operations by the user, a transport amount of the print medium 100, and the like. The control substrate 18 is formed so as to be able to control the drive device provided in the printing device 2, such as the transport motor 52. In the print head 42, the control substrate 18 supplies voltage to a pump that supplies ink from an ink tank and to piezoelectric elements provided in the nozzle sections 41 to 47 of the print head 42, and causes them to operate. By this, the printing device 2 forms dots by ejecting ink droplets from each of the nozzles of the nozzle sections 41 to 47. The control substrate 18 is configured so as to cause the light emitting element to emit light and so as to acquire a detection value of the label detecting device 56. In other words, the label detecting device 56 functions as a detection means in cooperation with the control substrate 18.

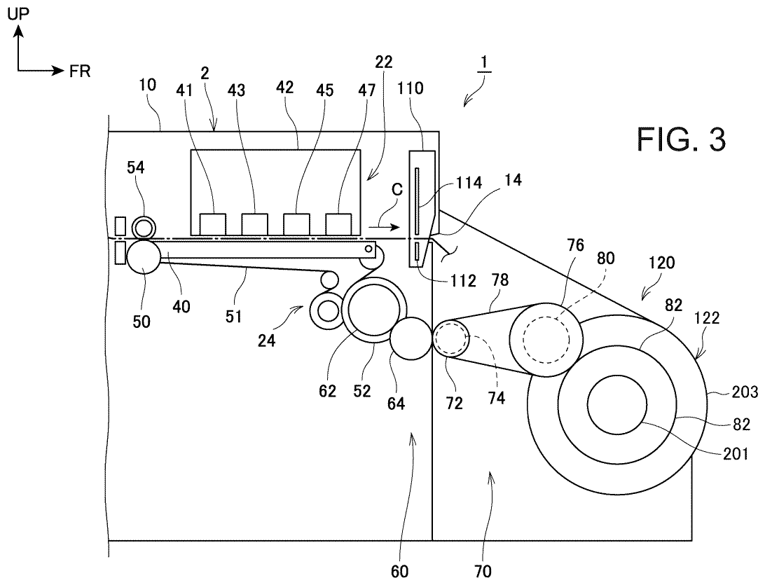

FIG. 3 is a side view of a main part of the printing and winding system 1, showing each part related to the transport path R. In FIG. 3, a lever 90 and a friction section 130 are omitted. As shown in FIG. 2 and FIG. 3, the front surface of the printing device 2 is configured so that the winding device 120 can be detachably attached below the sheet discharge port 14. The winding device 120 has a winding drum 122 that winds up the print medium 100 discharged from the sheet discharge port 14. The winding drum 122 is a shaft member of circular cylindrical shape or cylindrical shape whose longitudinal direction extends along the intersecting direction I. The winding drum 122 corresponds to a “winding section.” The winding drum 122 is driven by power input from the transport motor 52 via a printing side power transmission mechanism 60 provided by the printing device 2 and the winding side power transmission mechanism 70 provided by the winding device 120.

As shown in FIG. 3, the printing side power transmission mechanism 60 has an output gear 62 that is connected to the output shaft of the transport motor 52, and a coupling gear 64 that meshes with the output gear 62.

The winding side power transmission mechanism 70 has a coupling gear 72 provided at an end section of the winding device 120 that is the printing device 2 side. The winding side power transmission mechanism 70 has a small pulley 74 that shares the same shaft with the coupling gear 72 and a large pulley 76. An endless belt 78 is wound around the small pulley 74 and the large pulley 76. The winding side power transmission mechanism 70 has an intermediate gear 80 that shares the same shaft with the large pulley 76, and a shaft gear 82 that meshes with the intermediate gear 80. The shaft gear 82 shares the same shaft with the winding drum 122. The shaft gear 82 corresponds to a “drive force transmission member.”

In the printing and winding system 1, when the winding device 120 is attached to the front surface of the printing device 2, the coupling gear 64 meshes the coupling gear 72. By this, the printing side power transmission mechanism 60 and the winding side power transmission mechanism 70 are connected. When the transport motor 52 is driven such that the print medium 100 is fed in the forward feed direction, the winding drum 122 is driven by power input from the transport motor 52 via the printing side power transmission mechanism 60 and the winding side power transmission mechanism 70.

The winding drum 122 rotates toward the front side of the printing device 2 to wind up the print medium 100 discharged from the sheet discharge port 14. When the winding device 120 is used, the printing device 2 does not cut the print medium 100 by the cutter unit 110, and discharges the print medium 100 from the sheet discharge port 14 in the elongated state. For example, the winding device 120 can perform, by a single operation of the printing device 2, printing on the entire roll of the print medium 100 accommodated in the accommodation section 20 and can wind up the print medium 100 around the winding drum 122 by rotating the winding drum 122 in a direction to wind up the print medium 100.

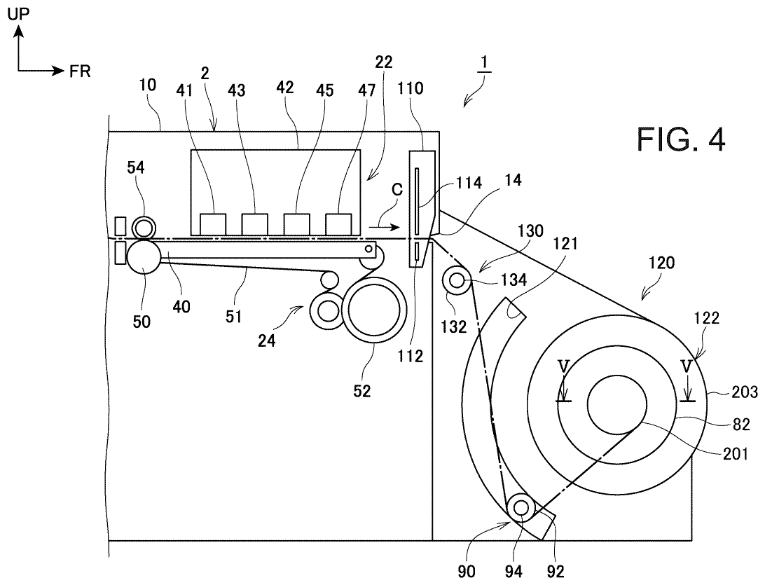

FIG. 4 is a side view of a main part of the printing and winding system 1, showing each part related to the transport path R. In FIG. 4, the printing side power transmission mechanism 60 and the winding side power transmission mechanism 70 are omitted. As shown in FIG. 4, the winding device 120 has a lever 90. The lever 90 has a lever roller 92 and a roller shaft 94 that rotatably supports the lever roller 92.

One end section of end sections of the roller shaft 94 is inserted into a movement opening 121 provided in the winding device 120. The movement opening 121 is an opening section arranged between the sheet discharge port 14 and the winding drum 122 in the transport direction C. The movement opening 121 is formed, as viewed from the intersecting direction I, in an arc shape centered on the rotation shaft of the winding drum 122. The roller shaft 94 inserted into the movement opening 121 is supported by the winding device 120 in a cantilever manner so as to extend in parallel with the winding drum 122 in a state where the roller shaft 94 is biased downward in the vertical direction by a biasing member such as a spring.

The lever roller 92 has a cylindrical shape that extends substantially parallel to the winding drum 122 in the state in which the roller shaft 94 is inserted. The lever roller 92 has a length dimension at least equal to or greater than the width dimension of the print medium 100. The outer peripheral surface of the lever roller 92 is formed of a rubber material or the like having a predetermined friction coefficient.

The print medium 100 discharged from the sheet discharge port 14 winds around a lower portion of the outer peripheral surface of the lever 90, and then is wound up around the winding drum 122. As described above, the lever 90 is attached to the winding device 120 in a state of being biased by the biasing member via the movement opening 121. By this, the lever 90 can move up and down along the vertical direction depending on tension of the print medium 100 winding around it. Therefore, the printing and winding system 1 can reduce the tension applied to the print medium 100 by the lever 90. In the present embodiment, the lever 90 is movable along the vertical direction from below the rotation shaft of the winding drum 122 to a position substantially the same height as the rotation shaft of the winding drum 122.

In the winding device 120, the print medium 100 is transported in a state bent downward as the print medium 100 winds around the lever 90. By this, even in a case where variation occurs in an attachment position of the winding device 120 when the winding device 120 is attached to the printing device 2, the printing and winding system 1 can suppress skewed transport of the print medium 100.

The lever roller 92 is driven to rotate by friction against the print medium 100 being transported. Therefore, the printing and winding system 1 can suppress the printed surface of the print medium 100 from being rubbed by the lever 90.

The winding device 120 has a friction section 130. The friction section 130 has a friction roller 132 and a roller shaft 134 that rotatably supports the friction roller 132. The roller shaft 134 is fixed so as to extend substantially parallel to the lever 90 between the sheet discharge port 14 and the lever 90 in the transport direction C.

The friction roller 132 has a cylindrical shape that extends substantially parallel to the winding drum 122 in the state in which the roller shaft 134 is inserted. The friction roller 132 has a length dimension that is at least equal to or greater than the width dimension of the print medium 100. The outer peripheral surface of the friction roller 132 is formed of a rubber material or the like having a predetermined friction coefficient. The print medium 100 discharged from the sheet discharge port 14 winds around the upper portion of the outer peripheral surface of the friction roller 132, and then is wound up around the winding drum 122 via the lever 90.

When the print medium 100 is transported in the forward feed direction, a force occurs on the print medium 100 in a direction of pulling the print medium 100 out from the printing device 2. In the present embodiment, since friction resistance is applied by the friction n roller 132, friction force that is directed in the opposite direction to the said force is applied the print medium 100. By this, the winding device 120 can suppress a decrease in transport accuracy of the print medium 100 by the printing device 2. Therefore, the printing and winding system 1 can suppress the shifting of the ink landing positions, thereby suppressing a reduction in print quality.

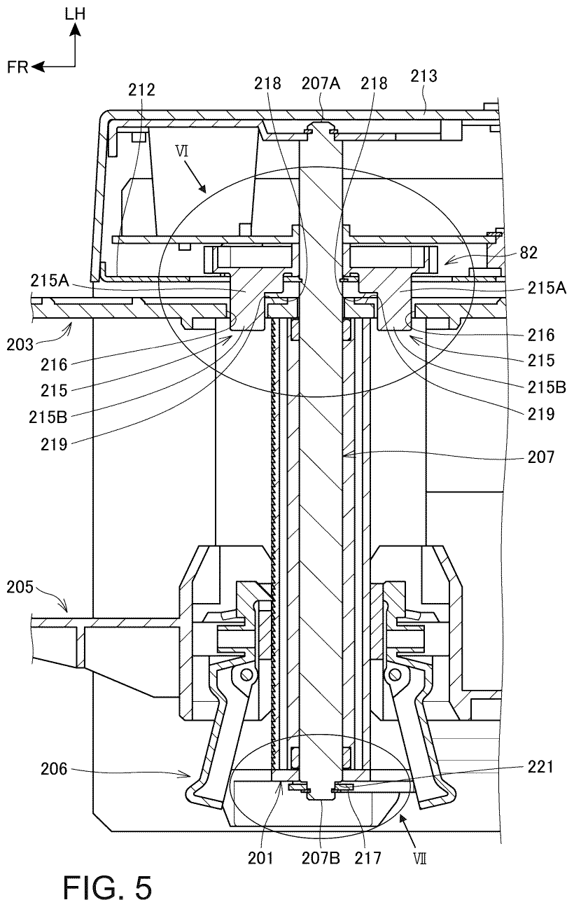

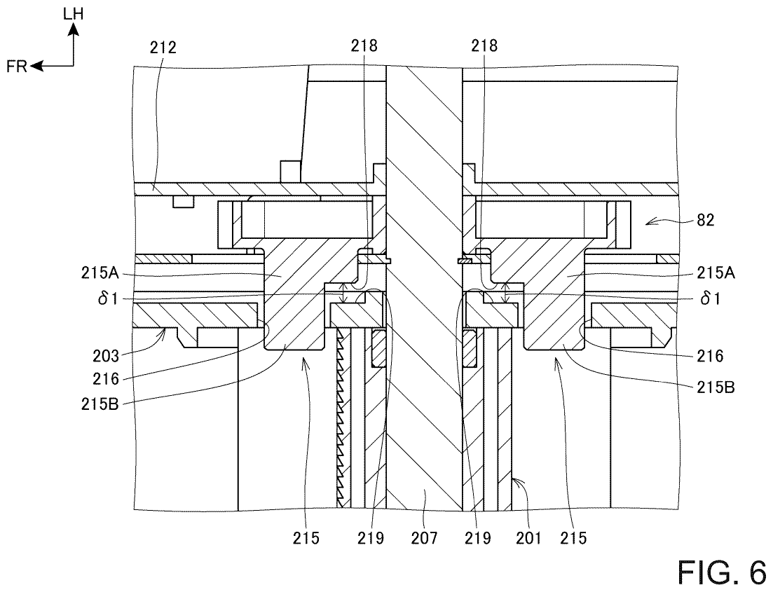

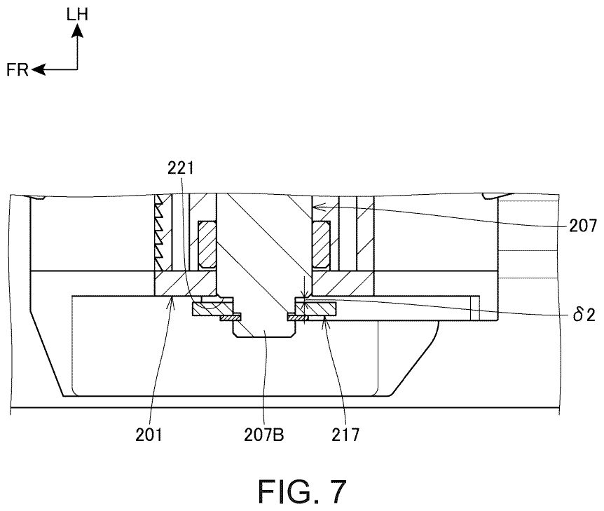

FIG. 5 is a V-V cross-sectional view of FIG. 4. FIG. 5 is a cross-sectional view cut by a plane that is orthogonal to the vertical direction and that is parallel to the support shaft 207 so as to pass the support shaft 207, as viewed from above. FIG. 6 is an enlarged view showing the range covered by VI in FIG. 5. FIG. 7 is an enlarged view of the range indicated by VII in FIG. 5. The winding drum 122 winds up the print medium 100 discharged from the sheet discharge port 14 of the printing device 2. As shown in FIG. 5, the winding drum 122 has a winding core 201 that winds up the print medium 100 on its peripheral surface. The winding drum 122 has a base flange 203 that guides a winding position of the print medium 100 when the print medium 100 is wound up around the winding core 201, and a tip flange 205 that is attached to a tip end side of the winding core 201 so as to face the base flange 203. The tip flange 205 includes a positioning lever 206. By operating the positioning lever 206, the tip flange 205 can be moved in the shaft direction of the winding core 201 to change its attachment position.

The winding drum 122 is rotatably supported by the support shaft 207. The support shaft 207 is supported in a so-called cantilever manner by an inner member 212 and an outer member 213, which form the frame of the winding device 120. In the following description, of end sections of the support shaft 207, an end section that is supported by the inner member 212 and the outer member 213 is referred to as a first end section 207A, and the other end section that is located at the opposite side from the first end section 207A is referred to as a second end section 207B.

The inner member 212 is arranged parallel to and facing the base flange 203. The outer member 213 is arranged on the opposite side from the base flange 203 with the inner member 212 interposed therebetween. The shaft gear 82 of the winding side power transmission mechanism 70 is arranged between the inner member 212 and the outer member 213. The support shaft 207 passes through the shaft gear 82.

As shown in FIG. 6, a plurality of protrusion sections 215 are formed in the shaft gear 82. The protrusion sections 215 correspond to a “first engagement section.” A plurality of through holes 216 that engage the plurality of protrusion sections 215 are formed in the base flange 203. The through holes 216 correspond to a “second engagement section.” The printing and winding system 1 causes the protrusion sections 215 provided in the shaft gear 82 to engage with the through holes 216 provided in the base flange 203, and causes the winding core 201 to rotate by rotating the base flange 203. The base flange 203 corresponds to a “flange.”

Each protrusion section 215 has a base section 215A that is formed on the shaft gear 82 and an engagement protrusion section 215B that is formed on the base section 215A and engages with the through hole 216. In a normal state where the base flange 203 is located at a reference position, a first gap δ1 is formed between the base section 215A and the base flange 203 to allow the winding core 201 to move in the longitudinal direction of the support shaft 207. In the following description, in the base section 215A, a surface facing the base flange 203, in which the through hole 216 is formed, is referred to as a protrusion section side facing surface 218, and in the base flange 203, in which the through hole 216 is formed, a surface facing the protrusion section side facing surface 218 is referred to as a through hole side facing surface 219.

As shown in FIG. 7, a restriction ring 217 that restricts the movement of the winding core 201 in the shaft direction is attached to the tip end section of the support shaft 207. The restriction ring 217 corresponds to a “movement restriction section.” A gap is provided between the tip end section of the winding core 201 and the restriction ring 217 to form a second gap 82 that allows the winding core 201 to move in the longitudinal direction of the support shaft 207. In the following description, in the winding core 201, a surface facing the restriction ring 217 is referred to as a winding core side facing surface 221.

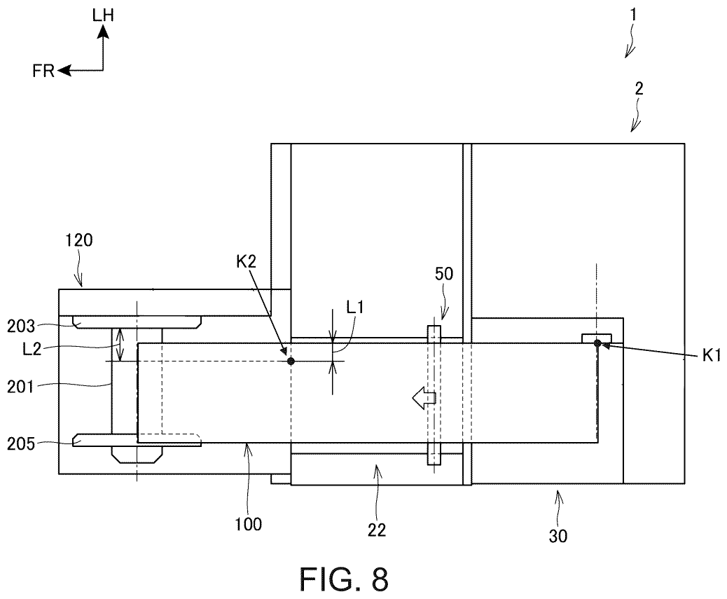

FIG. 8 to FIG. 12 are plan views showing an outline of the printing and winding system 1. In the printing and winding system 1, factors such as assembly errors and inclinations in various parts of the system cause variations that deviate from a reference state by a predetermined dimension. If there are assembly errors in various parts, then as shown in FIG. 8, a positional variability L1 from a paper edge reference of main body K1 to a winding positioning K2, a positional variability L2 from the winding positioning K2 to a side surface of the base flange 203, and so on, will occur.

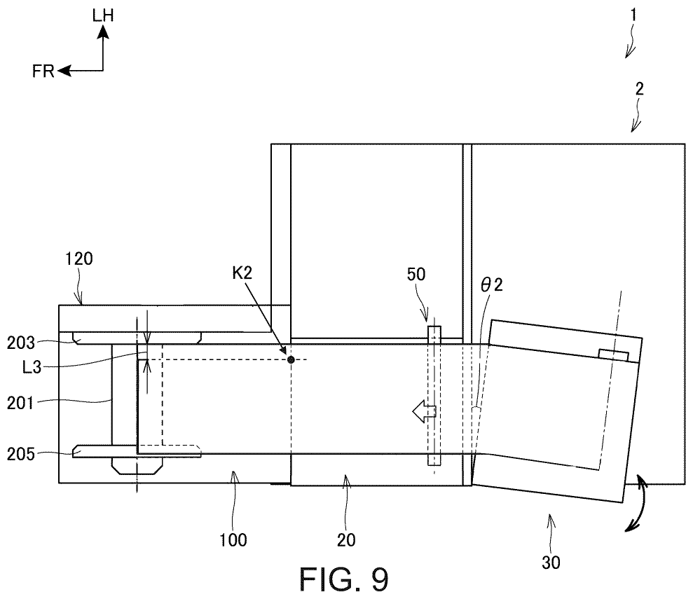

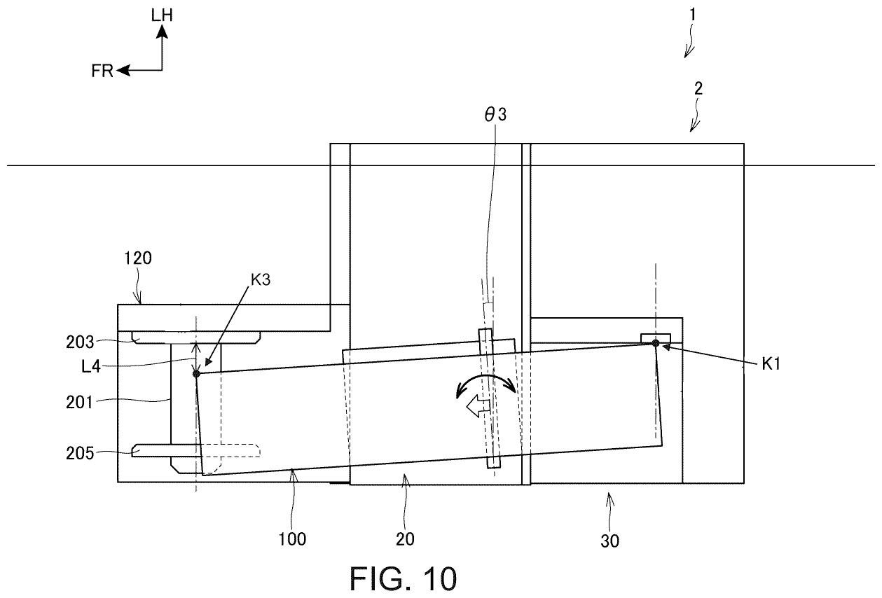

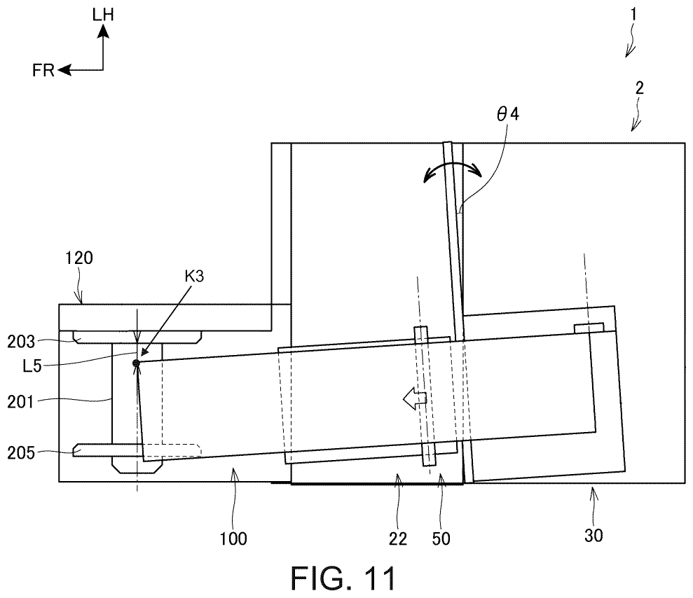

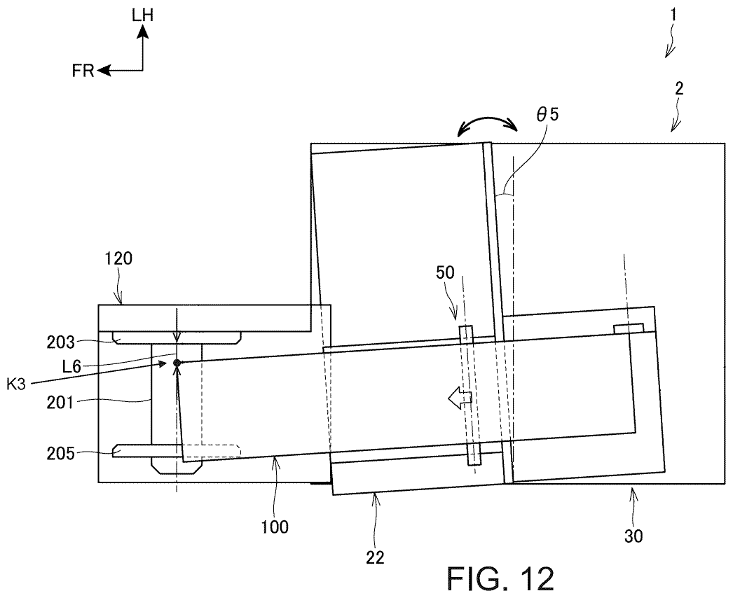

If the paper guide unit 30 is inclined by θ2, as shown in FIG. 9, a positional variability L3 from the winding positioning K2 to the side surface of the base flange 203 will occur. If the transport roller 50 is inclined by θ3, then as shown in FIG. 10, a positional variability L4 from the paper edge reference of main body K1 to a paper edge of flange section K3 will occur. If a rear end section of the printing section 22 is inclined by θ4, then as shown in FIG. 11, a positional variability L5 from the paper edge of flange section K3 to the side surface of the base flange 203 will occur. If the printing section 22 is inclined by θ5, then as shown in FIG. 12, a positional variability L6 from the paper edge of flange section K3 to the side surface of the base flange 203 will occur.

In the present embodiment, the variability L1 to L6 is calculated, and the total value thereof is defined as the paper edge variability of the winding device 120 with respect to the paper edge reference of main body K1. Based on this variability, in the present embodiment, the first gap δ1 is set to 3 mm on the base flange 203 side, and the second gap δ2 is set to 3.4 mm on the tip end section side of the support shaft 207. Within the range of each gap, the winding core 201 is configured to be movable in a direction of the support shaft 207.

Here, the relationship between transport torque T2 and transport load torque T1 will be described. In case the first gap δ1 and the second gap δ2 are almost non-existent, if paper edge variability of the winding device 120 occurs, then the winding operation is performed while the print medium strongly comes into contact with the side surface of the base flange 203 or the side surface of the tip flange 205. The transport load torque T1 generated at this time is expressed by the following equation (1).

$$T 1 = F \times r \qquad ( 1 )$$

In equation (1), T1 represents the transport load torque, F represents contact force between the sheet edge and the base flange 203 or the tip flange 205, and r represents a radius of the winding diameter.

Here, assuming that the transport torque is T2, then in the initial stage of winding, the radius r of the winding diameter is small, so T1<T2 is satisfied and no winding failure will occur. Toward the end of winding, the radius r of the winding diameter increases, so that T1>T2, that is, the transport load torque T1 becomes greater than the transport torque T2, causing a winding failure.

The winding drum 122 of the present embodiment is configured to be movable to both sides of the shaft direction in the shaft direction of the support shaft 207. By this, a distance that the winding drum 122 can move in the shaft direction of the support shaft 207 increases. Therefore, in the printing and winding system 1 of the present embodiment, when the transport load torque T1 exceeds the transport torque T2 at the end of winding, the winding core 201 can move in the shaft direction within the range of the first gap δ1 and the second gap δ2, so that the contact force F can be suppressed to be small. By this, in the printing and winding system 1, even when the radius r of the winding diameter increases, the relationship of T1<T2 can be maintained, and an occurrence of a winding failure can be suppressed. In the printing and winding system 1 of the present embodiment, the winding operation can be performed without bringing the print medium 100 into strong contact with either the base flange 203 or the tip flange 205. Therefore, the printing and winding system 1 can suppress an occurrence of the transport load torque T1, and suppress an occurrence of winding failure of the print medium 100.

In the printing and winding system 1 of the present embodiment, the winding of the print medium 100 by the winding core 201 may be started in a state where the winding core side facing surface 221 and the restriction ring 217 are in contact with each other. In this case, the engagement protrusion section 215B is formed to have such a length dimension that the protrusion section side facing surface 218 and the through hole side facing surface 219 do not come into contact with each other while the print medium 100 is being wound up around the winding core 201, and that the engagement protrusion section 215B does not come out from the through hole 216. By this, in the printing and winding system 1 of the present embodiment, the contact between the shaft gear 82 and the base flange 203 is suppressed, the winding failure is suppressed, and the shaft gear 82 and the winding core 201 are coupled in a state where the winding core 201 is movable in the shaft direction.

The embodiment described above is merely a specific example to which the present disclosure is applied. The present disclosure is not limited to the configurations of the above-described embodiments, and can be implemented in various aspects without departing from the gist of the present disclosure.

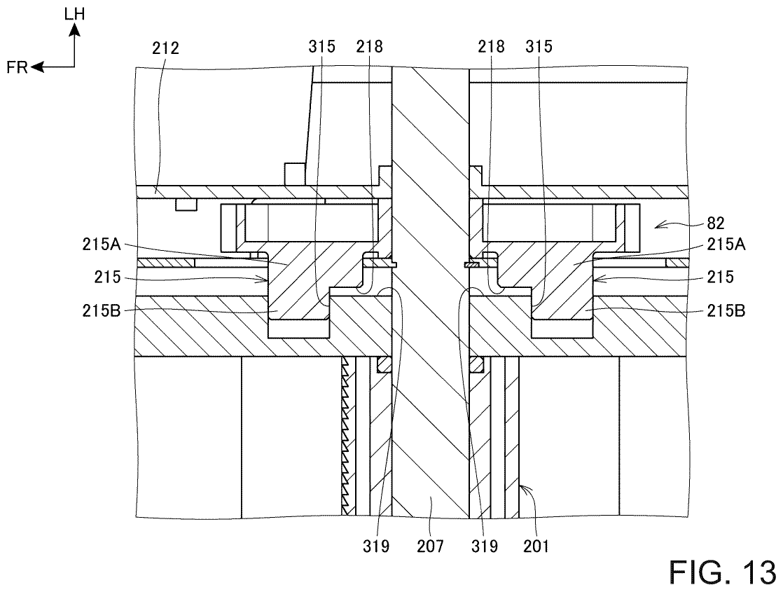

Next, a modification of the present embodiment will be described. FIG. 13 is an enlarged view of a range surrounded by VI in FIG. 5 according to a modification of the present embodiment. In the embodiment described above, a plurality of through holes 216 are formed in the base flange 203, where the protrusion sections 215 engage. However, the present disclosure is not limited thereto, and as shown in FIG. 13, the base flange 203 may be provided with recess sections 315 recessed toward the tip flange 205. The recess sections 315 are formed to have such a depth dimension that the entire engagement protrusion section 215B does not enter when the engagement protrusion section 215B is inserted, and that the engagement protrusion section 215B does not come out when the winding drum 122 moves to the tip flange 205 side. By this, a distance that the winding drum 122 can move in the shaft direction of the support shaft 207 increases. The recess section 315 corresponds to a “second engagement section.”

Here, assuming that in the base flange 203 in which the recess sections 315 are formed, a surface that faces the protrusion section side facing surface 218 is a recess section side facing surface 319. In the printing and winding system 1 according to this modification, winding of the print medium 100 by the winding core 201 may be started in a state where the winding core side facing surface 221 and the restriction ring 217 are in contact with each other. In this case, the engagement protrusion section 215B is formed to have such a length dimension that the protrusion section side facing surface 218 and the recess section side facing surface 319 do not come into contact with each other and that the engagement protrusion section 215B does not come out from the recess section 315 while the printed medium 100 is being wound around the winding core 201.

By this, in the printing and winding system 1 of the present embodiment, the contact between the shaft gear 82 and the base flange 203 is suppressed, the winding failure is suppressed, and the shaft gear 82 and the winding core 201 are coupled in a state where the winding core 201 is movable in the shaft direction.

Note that in the printing and winding system 1, the base flange 203 may be provided with the engagement protrusion sections 215B, and the shaft gear 82 may be provided with the recess sections 315.

In the above embodiments, a label printer is exemplified as the printing device 2. However, the printing device 2 is not limited to a label printer. The printing device 2 may be a device having a transport device that transports a print medium and a printing section that performs printing on the print medium. For example, the printing device 2 may be a large format printer, a textile printing machine that performs textile printing, or the like.

In the embodiments described above, a line head type of print head is shown as an example of the print head 42, but it is not limited to this and may be a serial head type of print head. The printing method of the print head 42 is not limited to an inkjet type.

The directions such as horizontal and vertical directions, various numerical values, and shapes in the above-described embodiments include so-called equal ranges that provide the same effects as those of the directions, numerical values, and shapes, unless otherwise specified.

### SUMMARY OF THE PRESENT DISCLOSURE

Hereinafter, a summary of the present disclosure is supplementally noted.

Supplemental note 1: The winding device includes a winding section that winds up a print medium discharged from a printing device; a support shaft that rotatably supports the winding section; and a drive force transmission member that transmits, from the printing device to the winding section, a drive force for rotating the winding section, wherein the winding section has a winding core configured to wind up the print medium around a peripheral surface of the winding core and a flange configured to guide a winding position of the print medium when winding up the print medium around the winding core, the drive force transmission member is configured to rotate the winding core by engaging a first engagement section provided on the drive force transmission member with a second engagement section provided on the flange, and the winding core is configured to be movable in a shaft direction along the support shaft. According to this, the winding device can suppress an occurrence of winding failure of the print medium.

Supplemental note 2: The winding device according to supplemental note 1 above, wherein one of the first engagement section and the second engagement section is a protrusion section, and the other is a through hole. According to this, the winding device is configured that the winding core is movable in the shaft direction of the support shaft in a state of connecting the drive force transmission member and the winding core.

Supplemental note 3: The winding device according to supplementary note 1, wherein the support shaft, in a longitudinal direction, has a first end section that is one end section located close to the flange and a second end section that is an other end section located at an opposite side from the first end section, the second end section is provided with a movement restriction section for restricting movement of the winding core in the longitudinal direction, and assuming that a surface of a member that serves as a base of the protrusion section and that faces a member in which the through hole was formed is a protrusion section side facing surface and assuming that a surface of the member in which the through hole was formed that faces the protrusion section side facing surface is a through hole side facing surface, and a surface of the winding core that faces the movement restriction section is a winding core side facing surface, then when winding of the print medium around the winding core is started in a state where the winding core side facing surface and the movement restriction section are in contact with each other, the protrusion section side facing surface and the through hole side facing surface do not come into contact with each other while winding up the print medium around the winding core. According to this, the winding device can suppress an occurrence of winding failure of the print medium.

Supplemental note 4: The winding device according to supplemental note 1 above, wherein one of the first engagement section and the second engagement section is a protrusion section and an other of the first engagement section and the second engagement section is a recess section. According to this, the winding device is configured that the winding core is movable in the shaft direction of the support shaft in a state of connecting the drive force transmission member and the winding core.

Supplemental note 5: The winding device according to supplemental note 4 above, wherein the support shaft, in a longitudinal direction, has a first end section that is one end section located close to the flange and a second end section that is an other end section located at an opposite side from the first end section, the second end section is provided with a movement restriction section for restricting movement of the winding core in the longitudinal direction, and assuming that a surface of the winding core that faces the movement restriction section is a winding core side facing surface, when winding of the print medium around the winding core is started in a state where the winding core side facing surface and the movement restriction section are in contact with each other, a tip surface of the protrusion section and a bottom surface of the recess section do not come into contact with each other while winding up the print medium around the winding core. According to this, the winding device can suppress an occurrence of winding failure of the print medium.

Supplemental note 6: The printing and winding system includes any one of the winding devices according to supplemental notes 1 to 5 and the printing device. According to this configuration, the printing and winding system achieves the same effect as that of the above-described winding device.

What is claimed is:

1. A winding device comprising:
a winding section that winds up a print medium discharged from a printing device;
a support shaft that rotatably supports the winding section; and
a drive force transmission member that transmits, from the printing device to the winding section, a drive force for rotating the winding section, wherein
the winding section has
a winding core configured to wind up the print medium around a peripheral surface of the winding core and
a flange configured to guide a winding position of the print medium when winding up the print medium around the winding core,
the drive force transmission member is configured to rotate the winding core by engaging a first engagement section provided on the drive force transmission member with a second engagement section provided on the flange, and
the winding core is configured to be movable in a shaft direction along the support shaft.

2. The winding device according to claim 1, wherein
one of the first engagement section and the second engagement section is a protrusion section, and the other is a through hole.

3. The winding device according to claim 2, wherein
the support shaft, in a longitudinal direction, has
a first end section that is one end section located close to the flange and
a second end section that is an other end section located at an opposite side from the first end section,
the second end section is provided with a movement restriction section for restricting movement of the winding core in the longitudinal direction, and
assuming that a surface of a member that serves as a base of the protrusion section and that faces a member in which the through hole was formed is a protrusion section side facing surface and assuming that a surface of the member in which the through hole was formed that faces the protrusion section side facing surface is a through hole side facing surface and a surface of the winding core that faces the movement restriction section is a winding core side facing surface, then when winding of the print medium around the winding core is started in a state where the winding core side facing surface and the movement restriction section are in contact with each other, the protrusion section side facing surface and the through hole side facing surface do not come into contact with each other while winding up the print medium around the winding core.

4. The winding device according to claim 1, wherein
one of the first engagement section and the second engagement section is a protrusion section and
an other of the first engagement section and the second engagement section is a recess section.

5. The winding device according to claim 4, wherein
the support shaft, in a longitudinal direction, has
a first end section that is one end section located close to the flange and
a second end section that is an other end section located at an opposite side from the first end section,
the second end section is provided with a movement restriction section for restricting movement of the winding core in the longitudinal direction, and
assuming that a surface of the winding core that faces the movement restriction section is a winding core side facing surface, when winding of the print medium around the winding core is started in a state where the winding core side facing surface and the movement restriction section are in contact with each other, a tip surface of the protrusion section and a bottom surface of the recess section do not come into contact with each other while winding up the print medium around the winding core.

6. A printing and winding system comprising:
the winding device according to claim 1 and
the printing device.
